(19) United States
(12) Patent Application Publication
(10) Pub. No.: US 2009/0083065 A1
(43) Pub. Date: Mar. 26, 2009

(54) Automatic Substantiation of Health-Related Purchases Using a HIPAA-Unregulated Network

(75) Inventors: Judith UNLAND, Elmhurst, IL (US); Mike KNAUFF, Libertyville, IL (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: DISCOVER FINANCIAL SERVICES LLC, Riverwoods, IL (US)

(21) Appl. No.: 11/860,446

(22) Filed: Sep. 24, 2007

(51) Int. Cl. G06Q 20/00; G06F 17/30; G06Q 50/00

(52) U.S. Cl. 705/2; 705/35; 705/44

(57) ABSTRACT

Transaction network operators can facilitate transactions of healthcare related goods via customers' tax-advantaged accounts, but without subjecting themselves to privacy regulations. Authorization for healthcare related purchases, including both price information and product information, is passed over PBM networks or other networks that already are regulation-compliant, while other purchase requests pass over existing payment card transaction networks. The PBM network divorces product information from the payment information, confirms eligibility, and passes the payment information to the general transaction network operator, indicating those funds are to come from the customer's tax-advantaged account. The network operator marries the payment information from the PBM with the other transaction information from the payment card network, withdraws appropriate funds from the tax-advantaged account, and notifies the merchant the amount that has been withdrawn from the tax-advantaged account. More generally, the methods and systems herein described can be used generally to divorce product information from financial transactions.

### FIELD OF THE INVENTION

This invention pertains generally to the field of consumer electronic transaction systems and more particularly to the purchase of healthcare related products and services over such transaction systems.

### BACKGROUND

In recent years, the federal government has made a variety of healthcare related programs available in attempt to combat increasing costs of healthcare. Several of these programs are in the form of tax-advantaged accounts that are designated for healthcare related expenditures. These include flexible savings accounts (FSAs), health savings accounts (HSAs) and health reimbursement arrangements (HRAs). While the specific limitations of these programs vary, the general principle remains the same: pre-tax funds are allocated into an account, generally through one's employer, and are later used to pay for qualifying healthcare related expenses.

One impediment to using such accounts, however, has been the need to substantiate purchases. That is, the employer or account holder is required to ensure that purchases made through these accounts indeed qualify as healthcare related expenses under Internal Revenue Service guidelines. Historically, this has been burdensome to consumers (who had to submit paper reimbursement forms and wait for payment) and to employers, who frequently had to “pay and chase” when it was subsequently discovered that an employee's purchase did not qualify. To help alleviate these issues, and to promote the usage of such accounts even further, the IRS issued rulings that, when followed, allow for consumers to use debit or pre-paid cards that are linked to their tax-advantaged healthcare accounts. Generally, these IRS rulings require most merchants to use an “Inventory Information Approval System” (IIAS) that determines a product's qualification by looking up its stock keeping unit number (SKU) in a database if the merchant wishes to accept such debit or prepaid cards. In this manner, the consumer benefits since no reimbursement forms are required, the employer benefits from knowing that the purchase has been substantiated and the merchant benefits from the proceeds of the sale.

More recently, some operators of payment card transaction networks have attempted to devise payment systems that allow debit or prepaid transactions for tax-advantaged accounts to be performed over their networks. However, there is an additional cost that is borne—and often overlooked—under such systems due to other governmental regulations. In particular, the Health Insurance Portability and Accountability Act (HIPAA) imposes strict requirements on any entity that has access to “protected health information” (PHI). Because these systems identify specific healthcare related product information (via SKU) with personal identity information (e.g., name), the networks over which these transactions take place may unwittingly subject themselves to HIPAA's Privacy Rule.

### BRIEF SUMMARY OF THE INVENTION

Ways are provided for allowing transaction network operators to facilitate transactions of healthcare related goods via customers' tax-advantaged accounts, but without subjecting themselves to privacy regulations of HIPAA. Authorization for healthcare related purchases, including both price information and product information, is passed over PBM networks or other networks that already are compliant with HIPAA. Authorization for other purchases is passed over existing payment card transaction networks. Information about healthcare related products is divorced from payment information. The PBM network divorces product information from the payment information and passes the payment information to the general transaction network operator, indicating those funds are to come from the customer's tax-advantaged account. The network operator marries the payment information from the PBM with the other transaction information from the payment card network, withdraws appropriate funds from the tax-advantaged account, and notifies the merchant the amount that has been withdrawn from the tax-advantaged account. In this manner, network operators can take advantage of quickly substantiating healthcare related purchases while avoiding possession of personally identifiable health information that might subject it to HIPAA's regulations.

In one aspect, a method is provided for facilitating the purchase of one or more products, including at least one healthcare related product, by a consumer, the method comprising receiving the one or more products and account information from the consumer, the account information corresponding to a tax-advantaged account for the consumer, transmitting the account information and pricing information for the one or more products over a first transaction network, transmitting product identifying information and pricing information over a second transaction network, and receiving a response over the first transaction network that the at least one healthcare related product was approved for purchase and funds corresponding to the pricing information for the at least one healthcare related product were debited from the tax-advantaged account.

In another aspect, a system is provided for facilitating the purchase of one or more products, including at least one healthcare related product, by a consumer, the system comprising one or more data entry devices for entering product identification information and consumer account information, a first transaction network for transmitting the account information and pricing information for the one or more products, a second transaction network for transmitting product identifying information and pricing information for the one or more products, a healthcare product database system on the second transaction network for determining that the at least one healthcare related product qualifies for tax-advantaged treatment, and a matching system on the first transaction network for receiving an approval message and pricing information for the at least one healthcare related product from the healthcare product database system on the second transaction network.

In still another aspect, a method is provided for debiting a tax-advantaged account an amount corresponding to a purchase of at least one qualifying healthcare related product comprising receiving a transaction authorization request over a first transaction network, the transaction authorization request comprising account information for a consumer; and a total amount to be authorized corresponding to the total price of one or more products to be purchased, receiving a qualifying message over a second transaction network, the qualifying message comprising transaction identifying information and a qualifying amount corresponding to the price of the at least one qualifying healthcare related product, matching the authorization request to the qualifying message, and causing the tax-advantaged account to be debited at most the qualifying amount.

In yet another aspect, a method is provided for facilitating the purchase of a qualified product by a consumer from a merchant, the method comprising receiving the product and account information from the consumer, the account information corresponding to a financial account for the consumer, transmitting the account information and pricing information for the product over a first transaction network, transmitting product identifying information and pricing information over a second transaction network for qualification, and receiving a response over the first transaction network includes first indicia that the product has or has not been qualified.

### BRIEF DESCRIPTION OF THE SEVERAL VIEWS OF THE DRAWING(S)

While the appended claims set forth the features of the present invention with particularity, the invention and its advantages are best understood from the following detailed description taken in conjunction with the accompanying drawings, of which:

FIG. 1 is a is a general overview of the operation of a method and system contemplated by an embodiment of the present invention;

FIG. 2 is a flow diagram illustrating a method for facilitating a purchase of healthcare related goods from a tax-advantaged account over a non-HIPAA-compliant network, in accordance with an embodiment of the invention;

FIGS. 3 and 4 are diagrams illustrating data structures used for facilitating a purchase of healthcare related goods from a tax-advantaged account over a non-HIPAA-compliant network, in accordance with an embodiment of the invention;

FIG. 5 is a flow diagram illustrating a method of matching authorization requests from a first network with substantiated instructions from second network, in accordance with an embodiment of the invention;

FIG. 6 is a flow diagram illustrating a method of debiting a tax-advantaged account for a purchase of healthcare related goods, in accordance with an embodiment of the invention; and

FIG. 7 is a diagram of a receipt generated when a purchase of healthcare related products are made from a tax-advantaged account, in accordance with an embodiment of the invention.

### DETAILED DESCRIPTION OF THE INVENTION

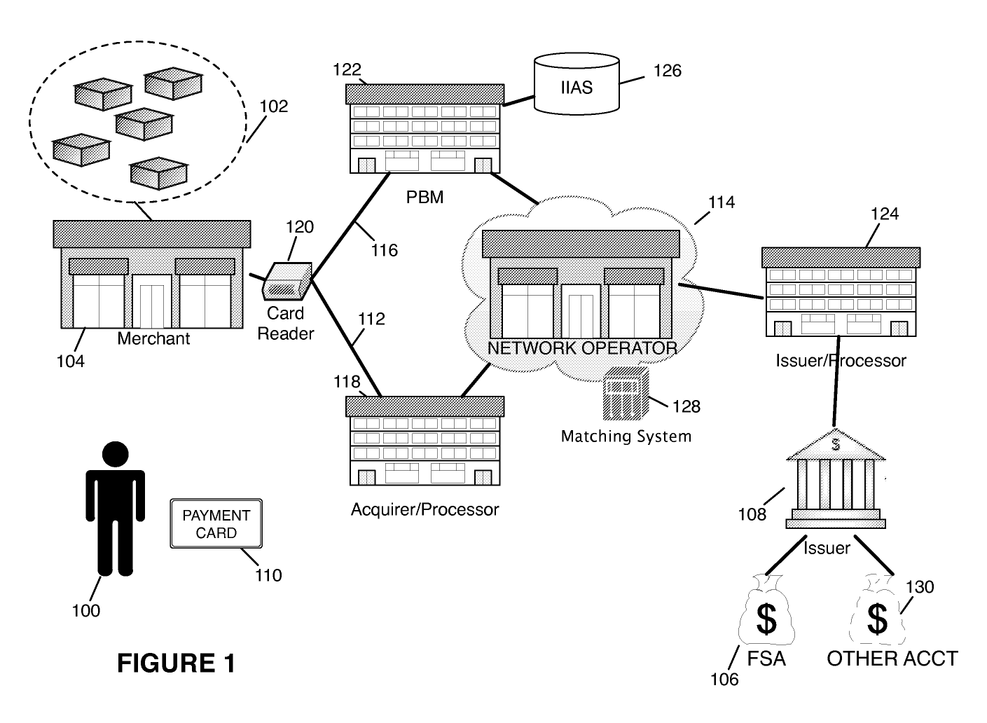

Turning to FIG. 1, an implementation of a system contemplated by an embodiment of the invention is shown with reference to an overall transaction network environment. A customer 100 wishes to purchase several products 102 from a merchant 104. Although the merchant 104 is typically a brick-and-mortar store, such as a grocery store or pharmacy, the merchant 104 can also be located remotely, such as during a transaction taking place over the telephone or Internet. The customer 100 participates in a tax-advantaged health program, such as an FSA, HSA or HRA that stores funds in a designated account 106. The customer 100 possesses a card 110 which is linked to the designated account 106, preferably held or managed by an issuing financial institution 108. The card 110 is preferably a debit or prepaid card, such that qualifying purchases made with the card can be debited from the designated account 106. Additionally, transactions using the card 110 are transmitted over a first transaction network 112, operated in conjunction with a network operator 114, such as the DISCOVER NETWORK. The merchant 104 further is connected over both the first transaction network 112 and a second transaction network 116. The first transaction network 112 preferably connects the merchant 104 to an acquirer/processor 118, as used in typical purchase transactions. The merchant 104 has an input device 120, such as a magnetic stripe reader, RFID reader, computer terminal, bar code reader, or other similar device capable of receiving information from the card 110. The second transaction network 116 connects the merchant 104 to a HIPAA-covered entity, such as a Pharmacy Benefits Manager (PBM) 122. Both the PBM 122 and the acquirer/processor 118 are in turn connected through the network operator 114 to the issuer 108 of the customer's 100 card 110. The issuer 108 is typically the bank or other entity that stores the funds in the customer's 100 designated account 106. Alternatively, the network operator 114 communicates with an issuer/processor 124 that in turn communicates directly with the issuer 108.

In an embodiment of the invention, purchases made by the customer 100 using the card 110 are sent for authorization approval in parallel over the two networks. Using the PBM's IIAS 126, the PBM 122 substantiates the healthcare related purchase items by preferably using SKU or UPC information to determine those products that are healthcare related and qualify for tax-advantaged treatment. The data sent to the PBM 122 can include “Level III” purchase data. Additionally or alternatively, the merchant identifies healthcare related products using its own IIAS, or identifies potentially healthcare related products by determining department codes the merchant has previously associated with product SKU or UPC code (e.g., all products from a store's “medical” department, which may include both eligible and ineligible items). SKU-level or UPC code information is preferably not sent over the first transaction network 112, however, so the operator 114 of the network will not have personally identifiable data regarding the customer's healthcare purchases that might otherwise subject it to HIPAA. Instead, the network operator 114 receives two authorization requests for the transaction: one from the PBM 122 for the amount of the substantiated healthcare related products, and one from the acquirer/processor 118 for the total amount of the transaction. The network operator 114 includes a matching system 128 for marrying data received over the first and second networks for a transaction. The network operator 114 checks that adequate funds are available from the tax-advantaged account 106 for the substantiated amount, and preferably causes the remainder to be charged to a linked payment card account 130. The network operator 114 then can inform the customer 100 via the first transaction network 112 that the transaction has been approved, and that a certain amount was debited from his tax-advantaged account 106 corresponding to qualifying healthcare related purchases. In embodiments of the invention, the network operator 114 is aware of the amount deducted from the tax-advantaged account 106, but is unaware of information regarding the nature or identity of the substantiated healthcare related products 102.

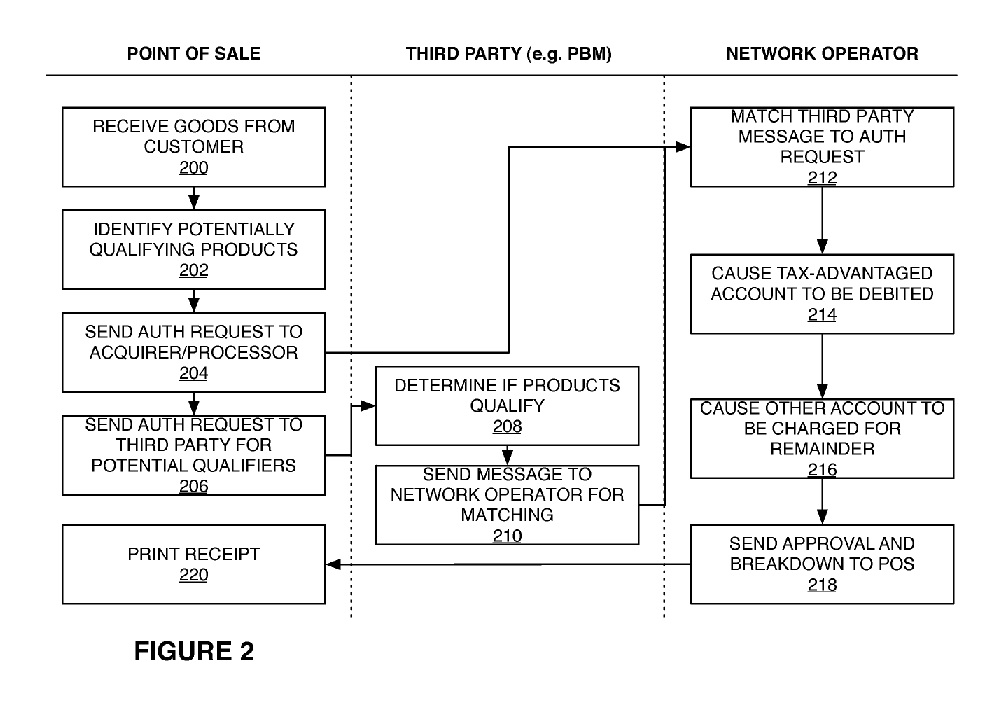

In greater detail, a technique of substantiating healthcare related purchases is now described with respect to FIG. 2, in accordance with an embodiment of the invention. A customer presents products for purchase at a merchant's point of sale, including a healthcare related product at step 200. At step 202, the merchant identifies those products that potentially qualify for tax-advantaged treatment. This identification can be performed by inspecting merchant-specific inventory codes (e.g., those products coming from particular departments within the merchant's store), or, alternatively, through the use of an IIAS at the merchant. Alternatively, step 202 is not performed by the merchant, but instead is performed by the PBM or other secondary network. In either case, the merchant preferably scans items for identifying information using a bar code scanner or other input device. After reading the customer's card information, preferably with a single swipe of the card's magnetic strip, the merchant sends two substantially simultaneous requests for authorization of the purchase, preferably in an automated process through its point-of-sale transaction systems. At step 204, a first authorization request is sent to an acquirer/processor over a standard transaction processing network. The first request preferably does not contain any SKU-level information identifying products to be purchased. At step 206, a second authorization request is sent to a PBM or other third party agency for authorization to debit a tax-advantaged account in the amount of the price of the healthcare related items. At step 208, the PBM determines which products are healthcare related using an IIAS or other mechanism, and at step 210, the PBM sends a message to the network operator with information relating to the total amount to be debited from the customer's tax-advantaged account.

The network operator receives the message from the PBM and the request from the acquirer/processor and matches them at step 212. The matching is preferably performed by comparing transaction identification information that is embedded in the message and the request, and is described in greater detail herein. The matched transaction can be passed to the issuer of the customer's card. At step 214, the network operator or issuer causes the customer's tax-advantaged account to be debited an amount corresponding to the message received from the PBM. The remainder of the purchase is preferably charged at step 216 to a credit account (or debit account or other type of account) associated with the customer and linked to the customer's card. At step 218, the network operator sends an approval message over the first network informing the customer of the breakdown between the amount of funds that were debited from his tax-advantaged account and the amount charged to his non-tax-advantaged account. Alternatively or additionally, the remainder of the purchase is not automatically charged to a non-tax-advantaged account, and the approval message also includes a request for the customer to provide another form of payment for the balance. At the point of sale, the merchant preferably prints a receipt at step 220 for the customer, on which it is detailed the respective amounts drawn from the tax-advantaged account and from a different source. The receipt does not show, however, a breakdown of which items contributed to those respective totals.

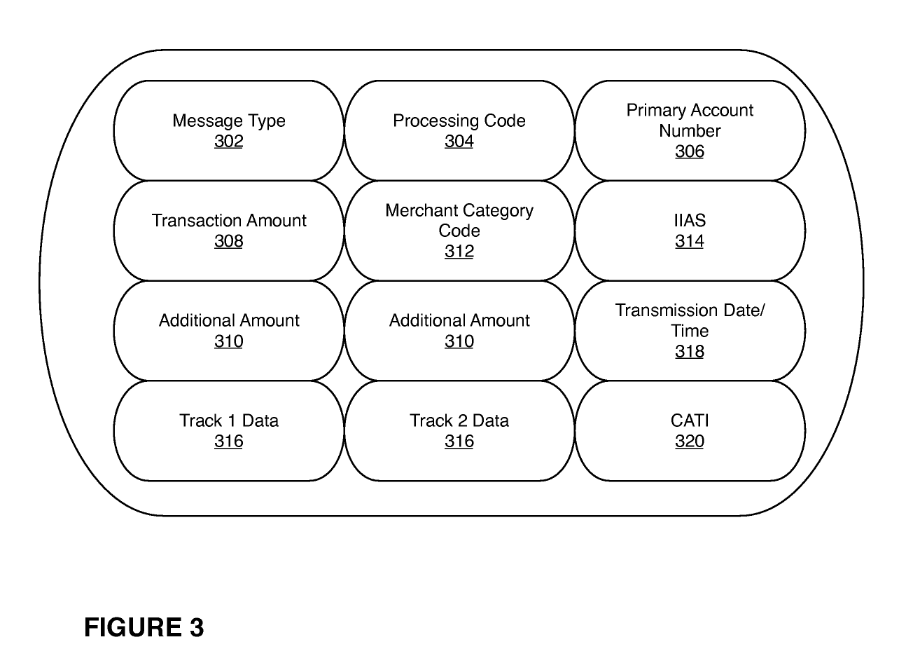

In embodiments of the invention, authorization requests sent from the acquirer/processor to the network operator comprise several fields that are used in facilitating the substantiated purchase of healthcare related items. Turning to FIG. 3, these fields can include a message type field 302 for indicating the message is an authorization request, a processing code field 304 for indicating this is for a purchase from a healthcare account, a primary account number (PAN) field 306 for indicating the customer's account number as displayed on the card, a transaction amount field 308 for indicating the total amount of items purchased at the point-of-sale, one or more additional amounts fields 310 for indicating amounts of items eligible for payment via a tax-advantaged account and other amounts, a merchant category code (MCC) field 312 for indicating the type of merchant at which the transaction is taking place, an IIAS field 314 for indicating whether the items to be purchased have been substantiated as being eligible for purchase from an FSA or other tax-advantaged account, track 1 and track 2 data fields 316 for indicating data from the magnetic stripe on the customer's card, a transmission date and time field 318 for indicating the date and time that the transaction enters the data interchange system, and a card acceptor terminal identification field (CATI) 320 for indicating the terminal ID of the device creating the transaction at the point of sale.

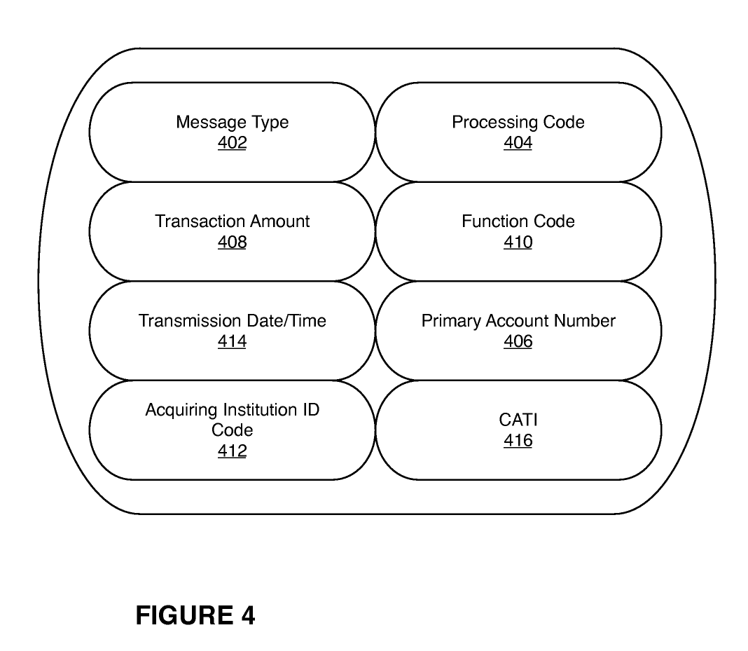

Similarly, the instruction message sent from the PBM to the network operator comprises several fields in an embodiment of the invention. Preferably, the instruction message is compliant with ISO 8583. With reference to FIG. 4, these fields can include: a message type field 402 for indicating the message is an authorization request, a processing code field 404 for indicating this is for a purchase from a healthcare account, a primary account number (PAN) field 406 for indicating the customer's account number as displayed on the card, a transaction amount field 408 for indicating the amount for items that have been determined to be eligible for tax-advantaged purchase, a function code 410 for indicating that the message should be used to update an authorization request, an acquiring institution identification code field 412 for indicating the identity of the PBM, a transmission date and time field 414 for indicating the date and time that the transaction enters the data interchange system, and a card acceptor terminal identification field (CATI) 416 for indicating the terminal ID of the device creating the transaction at the point of sale.

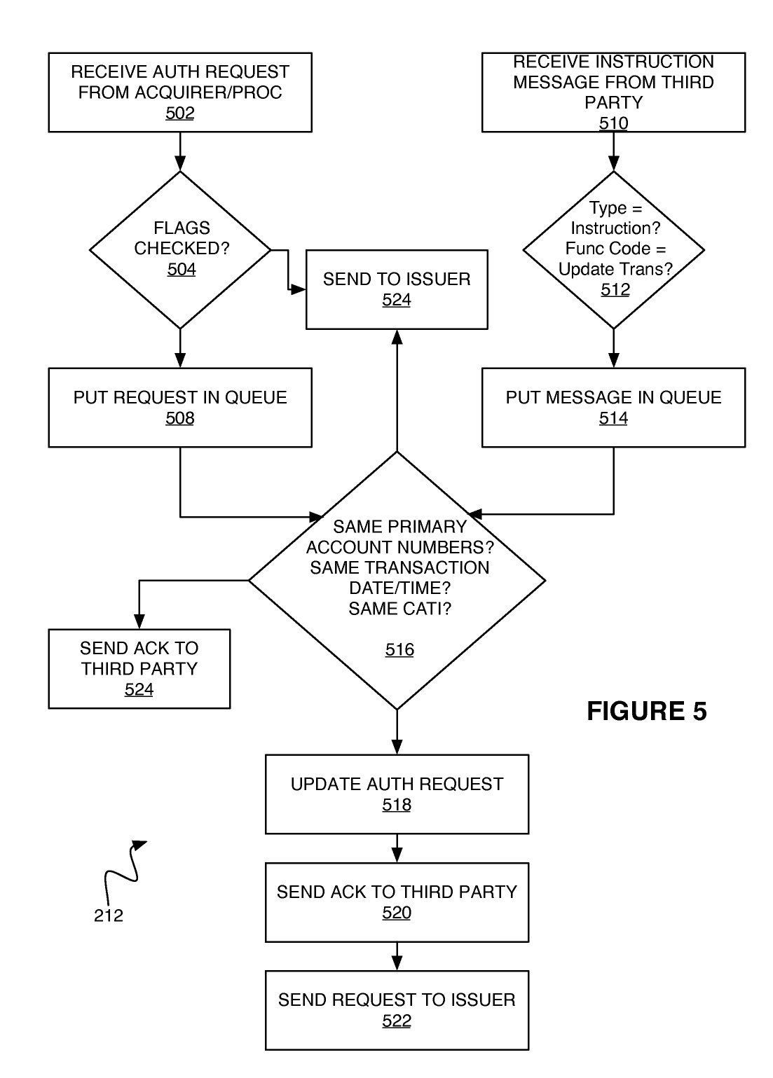

The matching process, shown for example at step 212 of FIG. 2, is now described in greater detail, in accordance with an embodiment of the invention. Turning to FIG. 5, a variety of the fields from the instruction message and authorization message are used to match messages and requests. At step 502, the network operator receives an authorization request from the acquirer/processor and inspects the request at step 504 to determine that: a) the PAN corresponds to an FSA or other tax-advantaged account; b) the MCC corresponds to a pharmacy or other valid merchant type; and c) the IIAS field is set to “False”. If any of these three conditions are not met, then the authorization request is forwarded to the issuer/processor at step 506 and the transaction proceeds without any substantiation. If all three conditions are met, then the request is placed in a queue at step 508 where it waits for a corresponding instruction message from the PBM.

At step 510, the network operator receives an instruction message from the PBM, and it verifies at step 512 that: a) the message's message type field indicates it is an instruction message; and b) the message's function code field indicates it is to update a transaction with an auto-substantiated amount. If both conditions are met, then the message is placed in a queue at step 514 where it waits for a corresponding authorization request from the acquirer/processor.

During regular time intervals, matching of authorization requests to instruction messages takes place at step 516 by comparing common fields. Preferably, the PAN field, transaction date and time field, and CATI field are compared. If the PAN and CATI fields are identical and the date/time fields are approximately identical, then a match has been found, and the authorization request is updated at step 518. In particular, the additional amounts field is updated to contain the amount of purchases substantiated by the PBM, and the IIAS indicator is set to “true”. An acknowledgment that the message was received and that the authorization request was updated is then sent to the PBM at step 520, and the updated request is sent to the issuer/processor at step 522.

If no instruction message is received in a given time interval corresponding to an authorization request, then the authorization request is forwarded to the issuer/processor at step 506 and the transaction proceeds without any substantiation. If no corresponding authorization request is received in a given time interval, an acknowledgement message is preferably sent to the PBM at step 524 indicating that the original message was received but that no authorization request was received, thus allowing the PBM to update its logs for reconciliation purposes.

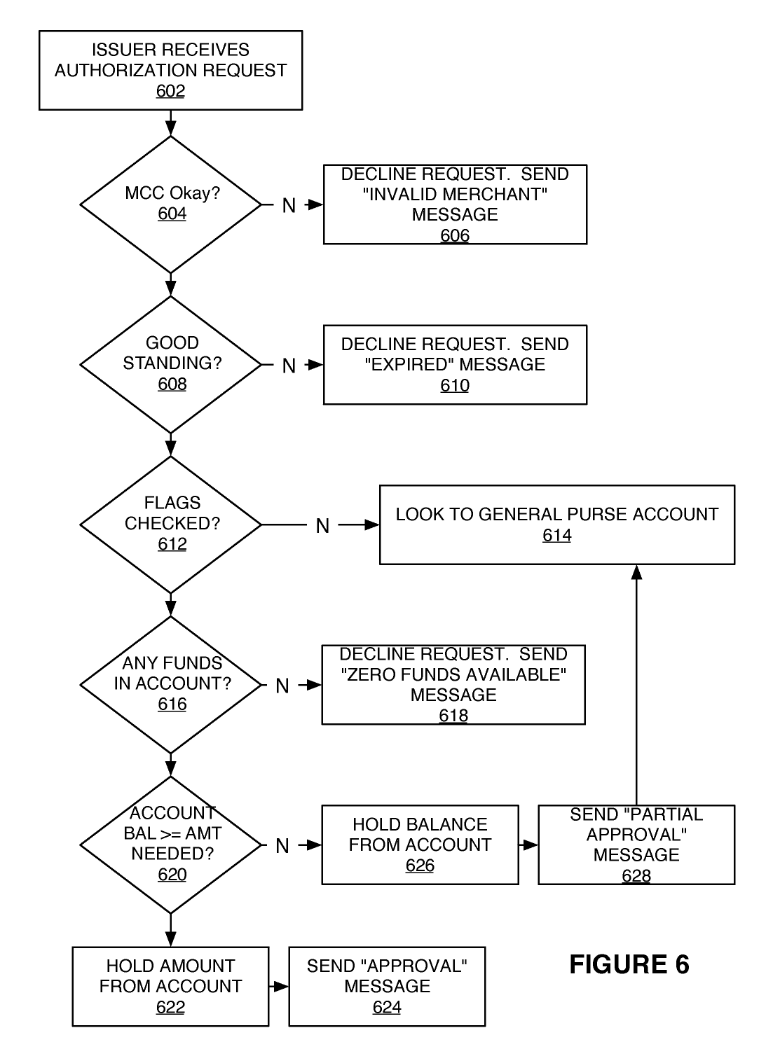

Once a match has been made between an authorization request from the acquirer/processor and an instruction message from the PBM, the payment process continues by the issuer/processor, as described with reference to FIG. 6 and in accordance with an embodiment of the invention. The issuer/processor receives the matched authorization request at step 602 and checks at step 604 that the merchant category code for the transaction is approved for auto-substantiation (i.e., that the merchant is a pharmacy or other approved type of store). If not, then the authorization request is declined at step 606 and a message is returned to point-of-sale indicating an invalid merchant. If the MCC is approved, then a check is made at step 608 that the customer is in good standing with his medical plan associated with the card. If not, then the authorization request is declined and at step 610 and a message is returned to point-of-sale indicating the customer does not have current medical coverage.

If the customer is in good standing, then it is determined whether the IIAS field of the request is “true” at step 612. If not, then no products have been substantiated and the transaction can proceed at step 614 by looking to a general expense purse associated with the card and processing in the ordinary course. In an embodiment of the invention, the general expense purse is one of a revolving credit account, debit account or the like. If the IIAS indicator is “true”, then at least one product is eligible for purchase via the tax-advantaged account. The issuer/processor determines at step 616 whether any funds are available in the tax-advantaged account and, if not, declines the request with a “Zero funds available” message at step 618. Otherwise, it checks at step 620 whether the available funds are at least as great as the amount determined by the PBM to be eligible for tax-advantaged purchase. If so, then a hold is placed on the tax-advantaged account for that amount at step 622, and an approval response is returned to the point-of-sale at step 624. Preferably, the approval response includes a) the original purchase amount, b) the amount held from the tax-advantaged account, and c) the remaining balance available in the tax-advantaged account for future purchases. Additionally, the merchant can be advised to ask the customer for an alternative form of payment if the original purchase amount exceeds the amount held (i.e., there were items that were not eligible for auto-substantiation). Alternatively, a charge can be automatically made from an associated general purse account, without requiring additional form of payment by the customer.

If adequate funds are not available in the tax-advantaged account, then a hold is placed on the balance of the account at step 626, and a partial approval response is returned to the point-of-sale at step 628 indicating that an alternative form of payment is required to cover the balance of the transaction. Alternatively, a charge can be automatically made from an associated general purse account, without requiring additional form of payment by the customer.

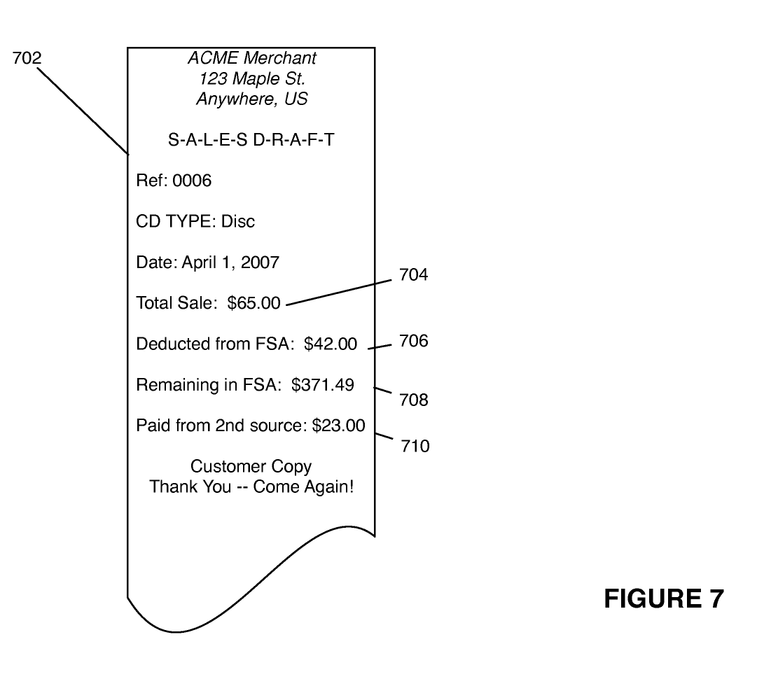

Turning to FIG. 7, an exemplary receipt as used in an embodiment of the invention is now described. The receipt 702 is preferably printed at a point-of-sale for a transaction where a customer has used a card to purchase healthcare related items with funds from a tax-advantaged account, as described above, for example. The receipt contains a line 704 indicating the total amount for all products sold during the transaction, including both healthcare related and non-healthcare related products. The amount deducted from the tax-advantaged account is shown on line 706. The remaining balance in the tax-advantaged account is shown on line 708. The amount paid from a secondary source (e.g., for non-healthcare related products or for healthcare products in the event insufficient funds are available in the tax-advantaged account) is shown on line 710.

More generally, the system and methods described above can be easily adapted to other uses where it is desirable to divorce certain data from the transaction. The separated data, preferably non-financial, can be sent over a secondary network (not necessarily the PBM network) for independent processing or eligibility determinations, while the financial data from the transaction can be sent over a primary transaction network. A matching system can then marry the original data with output from the secondary network's processing. In this way, the primary transaction network reaps the benefits of the secondary network's processing, while avoiding becoming aware of potentially sensitive or regulated non-financial information.

For example, the National Telecommuniations and Information Administration (NTIA) recently announced a “coupon program” whereby consumers may obtain vouchers to assist in purchasing digital-to-analog converter boxes, which may become necessary in the absence of over-the-air analog broadcasts in 2009. 47 C.F.R. 301. In an embodiment of the invention, the system and methods described above are used during a consumer's purchase of a converter box at a merchant to verify, for example, that the particular converter box is valid for purchase with the voucher. A third party maintains a database of acceptable converter box SKUs. The merchant's system, at time of purchase, divorces the SKU and/or voucher information from the other transaction data and sends it to the third party for verification over the secondary network. The third party then sends the verification results to the network operator where the results are matched with the transaction and dealt with accordingly.

In another embodiment, the systems and methods described above are used in conjunction with a brand or merchant loyalty program. For example, a third party can receive purchased product data from the merchant and make various determinations with respect to preferred brands. The third party's determinations are then matched up with the transaction data at the network operator or issuer-processor. In this way, a customer who purchases over, say, $10 of products under one brand's label, can receive a discount or coupon or other promotional reward. The determination of whether the discount or coupon should be granted is made remotely, preferably by the network operator or issuer-processor, where it can easily be applied to the current transaction.

In still another embodiment, the systems and methods described above are used in conjunction with a promotional rebate. For example, if a particular brand or model television is offering a $100 instant rebate, then at checkout, the relevant data (e.g., SKU and identifying data) is sent to a third party while the remaining transaction data is sent to the acquirer-processor over the primary network. The third party verifies that the SKU of the television indeed corresponds to the appropriate brand or model, and indicates this to the network operator or issuer-processor, where that indication is married to the remaining transaction data and dealt with accordingly. The customer may now only be charged the discounted amount.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A method for facilitating the purchase of one or more products, including at least one healthcare related product, by a consumer, the method comprising:
receiving the one or more products and account information from the consumer, the account information corresponding to a tax-advantaged account for the consumer;
transmitting the account information and pricing information for the one or more products over a first transaction network;
transmitting product identifying information and pricing information over a second transaction network; and
receiving a response over the first transaction network that the at least one healthcare related product was approved for purchase and funds corresponding to the pricing information for the at least one healthcare related product were debited from the tax-advantaged account.

2. The method of claim 1 wherein the second transaction network is subject to governmental regulations regarding the privacy of health-related information.

3. The method of claim 2 wherein the second transaction network is a pharmacy benefits management network.

4. The method of claim 1, the account information further corresponding to a non-tax-advantaged account, the method further comprising:
receiving a response over the first transaction network that funds corresponding to the pricing information of at least one product were charged to the non-tax-advantaged account.

5. A system for facilitating the purchase of one or more products, including at least one healthcare related product, by a consumer, the system comprising:
one or more data entry devices for entering product identification information and consumer account information;
a first transaction network for transmitting the account information and pricing information for the one or more products;
a second transaction network for transmitting product identifying information and pricing information for the one or more products;
a healthcare product database system on the second transaction network for determining that the at least one healthcare related product qualifies for tax-advantaged treatment; and
a matching system on the first transaction network for receiving an approval message and pricing information for the at least one healthcare related product from the healthcare product database system on the second transaction network.

6. The system of claim 5 wherein the operator of the healthcare product database system is subject to governmental regulations regarding the privacy of health-related information, and wherein the operator of the matching system is not subject to governmental regulations regarding the privacy of health-related information.

7. The system of claim 5 wherein the second transaction network is a pharmacy benefits management network.

8. The system of claim 5, the matching system further for causing an amount corresponding to the pricing information received from the healthcare product database system to be debited from a tax-advantaged account corresponding to the consumer.

9. The system of claim 8 the matching system further for causing an amount corresponding to the pricing information for the one or more products minus the pricing information received from the healthcare product database system to be charged to a non-tax-advantaged account.

10. A method of debiting a tax-advantaged account an amount corresponding to a purchase of at least one qualifying healthcare related product comprising:
receiving a transaction authorization request over a first transaction network, the transaction authorization request comprising:
account information for a consumer; and
a total amount to be authorized corresponding to the total price of one or more products to be purchased;
receiving a qualifying message over a second transaction network, the qualifying message comprising:
transaction identifying information; and
a qualifying amount corresponding to the price of the at least one qualifying healthcare related product;
matching the authorization request to the qualifying message; and
causing the tax-advantaged account to be debited at most the qualifying amount.

11. The method of claim 10 further comprising:
causing a non-tax-advantaged account to be charged an amount corresponding to at least the total amount minus the qualifying amount.

12. The method of claim 10 further comprising:
transmitting for review by the consumer a breakdown of the amount debited from the tax-advantaged account.

13. The method of claim 10 further comprising:
determining that insufficient funds are available for the qualifying amount in the tax-advantaged account;
causing the tax-advantaged account to be debited the balance of the account; and
causing the non-tax-advantaged account to be charged the total amount minus the amount debited from the tax-advantaged account.

14. The method of claim 10, the transaction request further comprising an indicator that purchase is taking place at a merchant without an inventory information approval system.

15. A method for facilitating the purchase of a qualified product by a consumer from a merchant, the method comprising:
receiving the product and account information from the consumer, the account information corresponding to a financial account for the consumer;
transmitting the account information and pricing information for the product over a first transaction network;
transmitting product identifying information and pricing information over a second transaction network for qualification; and
receiving a response over the first transaction network includes first indicia that the product has or has not been qualified.

16. The method of claim 15 wherein the response further includes second indicia that funds corresponding at least to the pricing information for the product were charged to the financial account.

17. The method of claim 16 wherein the first transaction network is a standard financial processing network and the response further includes indicia that that the funds charged for the product have been reduced based on the product having been qualified.

18. The method of claim 17 further comprising:
transmitting merchant identifying information along with the product identifying information and pricing information over the second transaction network;
wherein the response further includes indicia that the product has been qualified at least partially based on the identity of the merchant.

19. The method of claim 15 wherein the response further includes indicia that the product has not been qualified and that no funds were charged to the financial account.

20. The method of claim 15 further comprising:
receiving a voucher containing qualification information for the product; and
transmitting the qualification information along with the product identifying information and pricing information over the second transaction network;
wherein the response further includes indicia that the product has been qualified at least partially based on the voucher.
